(19) United States
(12) Patent Application Publication
(10) Pub. No.: US 2006/0213544 A1
(43) Pub. Date: Sep. 28, 2006

(54) Paintbrush cleaning device

(76) Inventor: James Schmitt, Bellingham, MA (US)

Correspondence Address: James Schmitt, 307 Oak St., Bellingham, MA, 98225, US

(21) Appl. No.: 11/090,360

(22) Filed: Mar. 28, 2005

(51) Int. Cl. B08B 3/04

(52) U.S. Cl. 134/184; 134/186; 134/900; 134/200

(57) ABSTRACT

A paintbrush cleaning and flushing device arranged to interface with a common household garden hose for unattended cleaning of a paintbrush comprises a hollow chamber formed by a clamshell enclosure for containment of a paintbrush. Enclosure being formed by two open sided box sections wherein open sided box sections comprise an inlet side; wherein pressurized water enters the enclosure, a baffling system for containing and directing water flow through paintbrush bristles, and an outlet side providing for a series of exit holes for paint contaminated water to exit clamshell enclosure.

### BACKGROUND

The disclosed invention relates to a device used for cleaning out paint brushes, and more particularly a time saving device arranged to function unattended when attached to a common garden hose utilizing pressurized water to flush paint and contaminants from that portion of paint brush bristles that is most difficult to clean.

Although there are any number of means for applying paint to a surface, the common paint brush is still considered one of the most efficient means to apply paint to a surface. Like most tools, paintbrushes have evolved over the years wherein there are numerous styles, sizes and materials used in their manufacture. There is also a considerable number of determining factors that come into play in selecting the right paintbrush for a particular application as modern chemical technology now provides us with paints having physical characteristics or compositions that define them as unique to particular applications. Within the many paint compositions offered, the two general types of paint most widely used by the homeowner, professional painter and average consumer are “water based paints” and “Oil based paints”. Although oil based paints remain popular for certain applications, tools containers and application devices including paint brushes require expensive cleaning solvents ; and usually considerably more time for cleanup operations. Water based paints however have experienced considerable technological advancements improving their durability and ease of application over recent years. And, have an advantage in that application tools, containers and paintbrushes can be cleaned with inexpensive tap water; greatly simplifying their use and making them ever more popular with professional's and homeowners alike. It should be noted that the disclosed invention is meant to address the cleaning of paintbrushes that utilize water based paints, brushes and tools.

Paintbrushes designed for the application of water based paints range from inexpensive foam rubber models and cheaply made bristle type throw away brushes to high quality bristle type brushes used by most professional painters. Although throw away brushes certainly have their place in the industry, bristle type throw away models are usually of poor quality due the necessity to keep their cost as low as possible. It is for this reason the majority of consumers and most all professional painters opt. for higher quality bristle brushes. Although they are expensive, they do normally offer increased performance and durability; even after repeated cleaning. Using a good bristle type paintbrush is usually more cost effective in terms of the finishes one can obtain as well as the possible longevity one can expect if the brush is cared for. The fact remains however that they are still both difficult and time consuming to keep clean and maintain properly. Unless the brushes are flushed out thoroughly with a pressurized water solution almost immediately after each and every use, they have a tendency to accumulate paint residue and buildup where the bristles enter the body of the brush, or area commonly referred to as the “heel” of the brush. And, if the cleaning procedure cannot be attended to almost immediately, the paint “buildup” problem will compound itself over multiple uses. When brush bristles become compromised due to lack of maintenance the result is usually an overall loss of bristle flexibility greatly effecting the capability to produce smooth and consistent painted finishes. It is well known by those familiar with the art, that failure to take the required time and effort to thoroughly flush out and remove contaminants from the paintbrush bristles shortly after use, will necessitate more frequent replacement of paintbrushes, resulting in considerable added expense.

There have been a number of innovative approaches and inventions introduced to the market in previous years addressing paintbrush cleaning problems outlined above. Mr. Dixon's “paint brush cleaning funnel” outlined in U.S. Pat. No. 4,823,424 describes a funnel shaped device fitted to a garden hose wherein a contaminated or used paintbrush can be inserted into the large diameter end of the funnel to a point where pressurized water entering the funnel from the smaller end has to pass up through the bristles performing the flushing action, thus carrying paint and contaminants up and out of the large end of the funnel device. Although this device does address the desirability to be able to “flush” the bristle area with fresh water, the internal geometry of the device actually restricts water flow by design as the brush bristles have a tendency to compact together as the brush is inserted deeper into the device impairing the flow of water to the all important “heel” area of the bristles. Although the series of “teeth” arranged inside the funnel would in fact help to divide or separate bristle hares and aid the flushing process, they can also traumatize, the bristle pattern by folding, crimping or even breaking off some of the bristles as the brush is twisted and maneuvered around inside the funnel effecting the overall longevity of the bristles of the brush. A final consideration is that the overall cleaning operation of the brush requires that the operator personally manipulate the brush inside the funnel device for the entire time while performing cleaning or flushing operations. The “Water Jet Spray Nozzle” outlined under Mr. Reyna's U.S. Pat. No. 5,381,964 depicts a somewhat different approach wherein a series ofjet spray nozzles extending from a manifold type housing can be inserted directly into the bristles of a paint brush. There is no doubt that a device of this type could comb through and flush contaminants from the “heel” portion of the bristles. However, again one would have to concern himself with the possibilities of traumatizing or damaging bristles with the digging, poking and scraping action that would be required for thorough flushing out of the problem areas. And, although Mr. Reyna's device might be effective in providing a solution to part of the paintbrush cleaning problem, it also requires manual manipulation to complete the cleaning operation as outlined for Mr. Dixon's invention.

A similar but somewhat simplified approach to solving the paintbrush cleaning problem is offered in Mr. Drukarov's U.S. Pat. No. 6,779,535 “Paint brush cleaning device” wherein the inventor provides for a single spray nozzle type probe to flush contaminants from the bristles. Here again, there is potential for effecting considerable bristle trauma or damage during cleaning. It is also required the device be manually operated by the user to perform the cleaning procedure.

It becomes obvious upon review of all three of these works that the efficient and effective flushing of the heel area of a paintbrush is in fact good practice as it will have a considerable positive effect on the performance as well as the useful life of a paintbrush. However, the aspect of longevity , the relatively delicate nature of the paintbrush bristle structure, and the desirability of a hands free paintbrush cleaning process, are areas that have not been addressed.

### SUMMARY

Accordingly, it is an object of the present invention to disclose a paintbrush cleaning system that will overcome the drawbacks of prior art systems by providing a simple inexpensive device arranged for using common household pressurized water for flushing paint and contaminates from the heel portion of paintbrush bristles.

It is also an object of the present invention to provide a paintbrush cleaning device that will accommodate a range of paintbrush sizes and configurations.

It is yet another objective of the present invention to provide a paintbrush cleaning device that allows for pressurized water to pass through a brush holding enclosure in such a way wherein the cleaning or flushing procedure does not create trauma to the bristle's heel portion of the paintbrush.

A final object of the invention is to provide a paintbrush cleaning or flushing device in the form of an enclosure that encapsulates the bristle portion of a paintbrush allowing for unattended operation.

A more complete appreciation of the subject matter of the present invention and the advantages thereof can be realized by referencing the following detailed description and referenced drawings wherein:

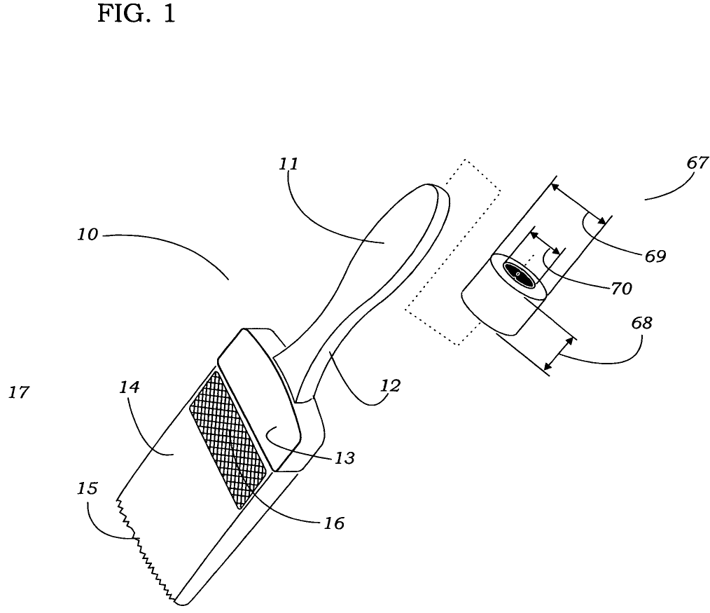

FIG. 1 is a general view of a typical paintbrush, it's component parts and optional bushing

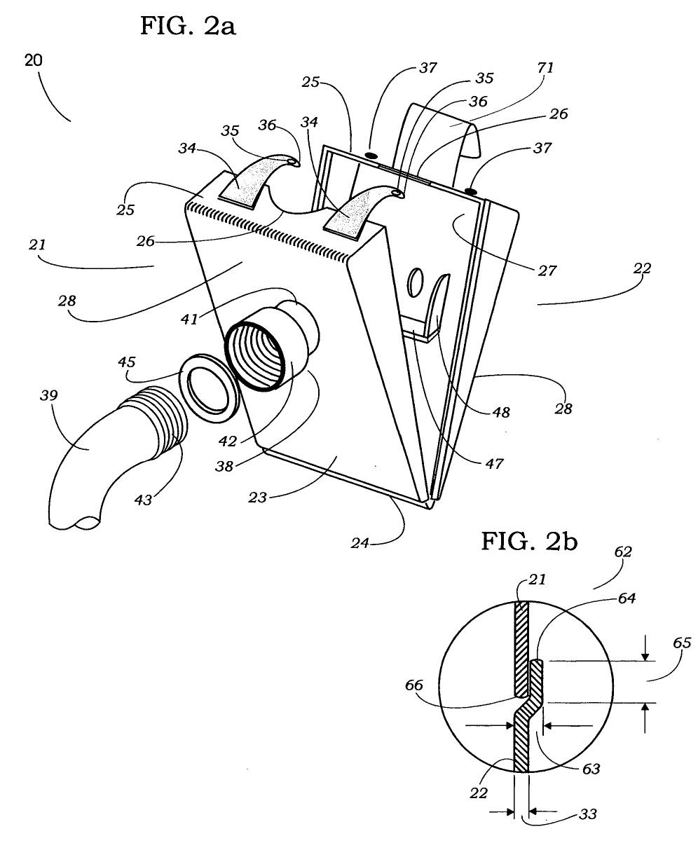

FIG. 2a is a isometric view of the subject invention in the opened position.

FIG. 2b is a magnified view of the lip seal.

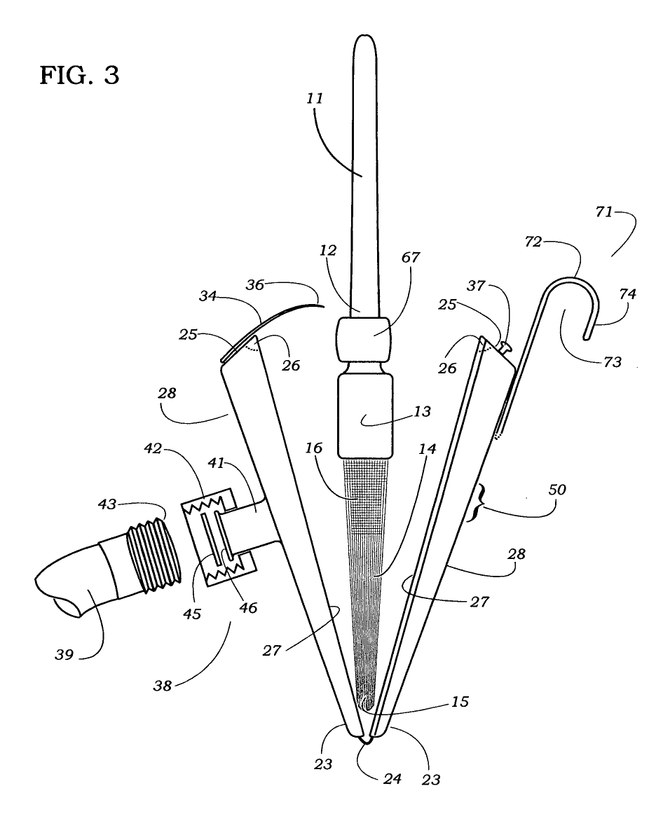

FIG. 3a is a plane view of the disclosed invention in the “open”0 position

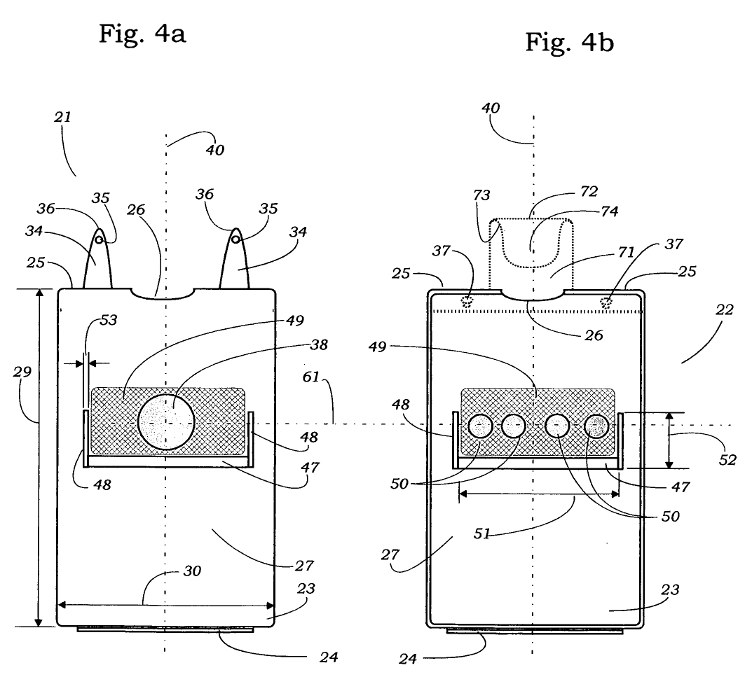

FIG. 4a and 4b are views of the internal details of enclosure.

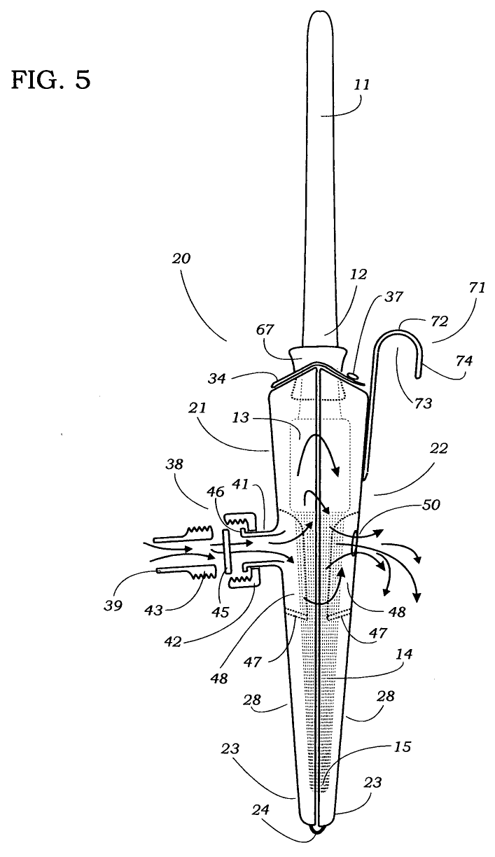

FIG. 5 shows plane cut-a-way view of pressurized water flow pattern.

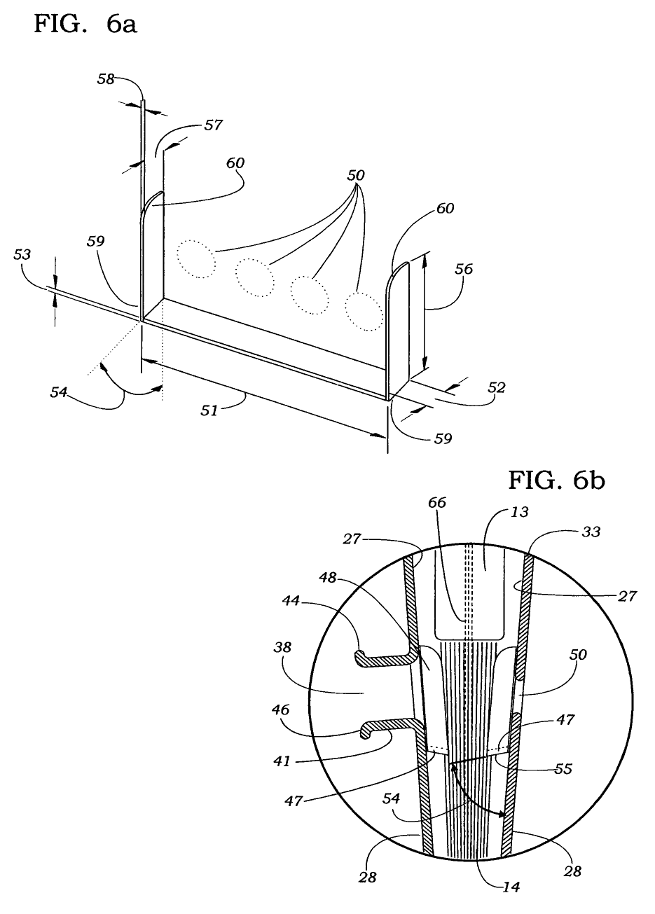

FIG. 6a is an isometric view of baffles.

FIG. 6b is a magnified cut-a-way view of baffles

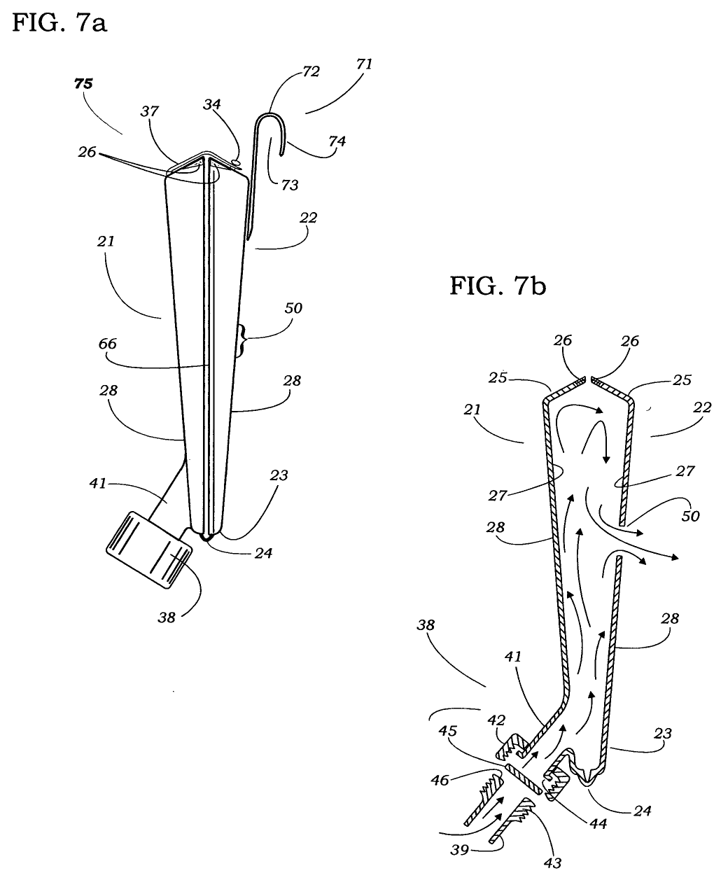

FIG. 7a shows optional configuration of enclosure

FIG. 7b is cut-a-way view of optional configuration

### DESCRIPTION

It is important to note that the following descriptive illustrations and approximate dimensions are for 2½ and 3″ paintbrushes and although overall dimensions may change to accommodate different sizes of brushes, geometric proportions for the depicted invention will remain consistent.

Referring now to FIG. 1

A common paint brush (10) is shown for the purpose of better defining the disclosed paintbrush cleaning invention wherein paintbrush (10) is comprised of handle (11) for the purpose of holding and manipulating paintbrush (10). Handle (11) is often designed with an area of minimal cross section herein referred to as the neck (12). Neck (12) allows user a more comfortable grip while holding handle (11) of paintbrush (10) during use. Body (13) is a component of paintbrush (10) configured to substantially fix handle (11) to body (13) of paintbrush (10) as well as provide a cavity for retaining an arrangement of bristles (14). Bristles (14) are the component of paintbrush (10) that retains paint when submerged into a paint supply allowing for uniform spreading of paint onto a surface to be painted. The immediate area where bristles (14) extend from body (13) of paintbrush (10) is commonly referred to as a heel (16). The point at which bristles (14) terminate from paintbrush (10) is commonly referred to as the tip (15). It should be noted that the subject and express purpose of the disclosed invention is to substantially simplify the users ability to clean and flush paint build up and contaminants from bristles (14) and more specifically, the heel (16) area of paintbrush (10).

Referring now to FIG. 2a

Wherein the paint brush cleaning device of the disclosed invention comprises clamshell type geometry herein referred to as enclosure (20). Enclosure (20) is configured to form a hollow rectangular chamber when in the closed position substantially encapsulating the body (13) and bristles (14) of paintbrush (10) to accommodate the flushing of paint and contaminants from paintbrush (10) during cleaning. In the disclosed preferred embodiment, enclosure (20) comprises a one piece molded plastic form consisting of two opposing and interlocking open sided wedge shaped box sections herein referred to as the inlet side (21) and the outlet side (22) of enclosure (20). Inlet side (21) and outlet side (22) to be substantially joined along their bottom ends (23) by an integrally molded hinge (24). Hinge (24) provides pivotal means for enclosure (20) inlet side (21) and outlet side (22) to be spread apart as shown in FIG. 3, allowing for insertion of paintbrush (10) into enclosure (20) in preparation for flushing out paint contaminants from heel (16) and bristles (14) of paintbrush (10). It is important to note that open sided wedge shaped box sections inlet side (21) and outlet side (22) of enclosure (20) comprise approximately the same basic shape and dimensions wherein open side of inlet side (21) and open side of outlet side (22) are mirror images of each other allowing their mirror image geometry to interface with each other to create enclosure (20). The exception to the mirror image characteristic of the basic shape of inlet side (21) and outlet side (22) is the edge (64) of outlet side (22) and the edge (66) of inlet side (21) which form sealing lip (62) as outlined in sealing lip (62) detail, shown in FIG. 2b .

Referencing FIG. 4a and 4b

Inlet side (21) and outlet side (22) of said open sided wedge shaped box sections comprising enclosure (20) are further defined as being constructed of one piece molded plastic. Each having a length (29) of approximately 6″ and a width (30) of approximately 3.75″. And, referencing FIG.2a again, a major depth (31) measured adjacent to top surface (25) of inlet side (21) and outlet side (22) of approximately 3/4″ and a minor depth (32) measured adjacent to bottom end (23) of inlet side (21) and outlet side (22) of approximately 1/4″. The preferred embodiment of enclosure (20) would be molded as one piece, maintaining a relative uniform thickness (33) or cross section of approximately .050″ as outlined in the magnified illustration FIG. 2b. referencing FIG.2a Wherein top surface (25) of inlet side (21) of enclosure (20) provides for two locking tabs (34). Locking tabs (34) are molded into top surface (25) of inlet side (21) of enclosure (20) and are provided for with snap holes (35) at outer most ends (36). Snap holes (35) are arranged to mate with integrally molded snap buttons (37) located on top surface (25) of outlet side (22) of enclosure (20). Locking tabs (34) and snap buttons (37) are provided for temporarily locking inlet side (21) of enclosure (20) to outlet side (22) of enclosure (20), retaining enclosure (20) in a closed position during paintbrush (10) flushing operations as shown in FIG. 5.

Referencing again FIG. 2a

Wherein pressurized water for cleaning and flushing contamination from paintbrush (10) is introduced to inside of hollow chamber forming enclosure (20), through water inlet (38) from a standard household garden hose (39). Water inlet (38) to be located on an approximate vertical line (40) as outlined in FIG. 4a and approximately equidistant from top surface (25) and bottom end (23) of enclosure (20).

Reference FIG. 3

Water inlet (38) extends outwardly approximately 1″ from external surface (28) of inlet side (21) on enclosure (20). Water inlet (38) comprises an integrally molded hollow stem (41) having a diameter of approximately 3/4″ in. and of a standard configuration as required to accommodate common garden hose (39) threaded end (43).

A standard internally threaded female fitting or hose connector (42) is provided for mating water inlet (38) to the externally threaded male portion of hose connection (43). Female hose connector (42) is retained on stem (41) of inlet side (21) by the integrally molded flange (44) located on outermost end of stem (41). Standard garden hose rubber washer (45) provides a seal between the end of male hose fitting (43) and front face (46) of stem (41) flange (44) for the purpose of preventing water leakage when male hose connection (43) on garden hose (39) is threaded into female hose connector (42) of water inlet (38) on enclosure (20) and connected to pressurized water supply.

Referring now to FIG. 4a and 4b

Wherein internal surfaces (27) of enclosure (20) inlet side (21) and outlet side (22) comprise a plurality of horizontal and vertical water flow directing baffles. Horizontal baffles (47) and vertical baffles (48) serve the purpose of directing pressurized water flow inside enclosure (20) as water moves from garden hose (39), into water inlet (38) into and through primary flushing area (49), through heel (16) of bristles (14) on brush (10), and out through escapement provided by exit holes (50) in outlet side (22) of enclosure (20) as depicted by flow arrows in fig.5.

Reference FIG. 4a and 4b

Wherein horizontal baffles (47) and vertical baffles (48) are integrally molded into internal surfaces (27) of inlet side (21) and outlet side (22) of enclosure (20). Horizontal baffles (47) and vertical baffles (48) geometry and locations are substantially identical on internal surfaces (27) for both inlet side (21) and outlet side (22) enclosure (20).

Referencing now FIG. 6a and 6b

Horizontal baffles (47) to measure approximately 2¼″in length (51), ¼″ in width (52) and have a cross sectional thickness (53) of approximately 1/16″. Horizontal baffles (47) to be angled downward toward bottom ends (23) of enclosure (20) forming angle (54) of approximately 60 degrees measured from underside (55) of horizontal baffle (47) and internal surfaces (27) of inlet side (21) and outlet side (22) of enclosure (20) as shown in fig.6b. Horizontal baffles (47) to be located on internal surfaces (27) approximately equidistant from of top surface (25) and bottom ends (23) of both inlet side (21) and outlet side (22) of enclosure (20) as shown in FIGS. 4a and 4b. Referring again to FIG. 6a Wherein vertical baffles (48) are provided; each having a length (56) of approximately 1″, a width (57) of approximately 1/4″ and a thickness or cross section (58) of approximately 1/16″. Vertical baffles (48) to be integrally molded into internal surfaces (27), positioned directly adjacent to and angled approximately 90 degrees relative to, outermost ends (59) of horizontal baffles (47). Vertical baffles (48) to be slightly Radiused (60) at their upper most ends for the purpose of keeping bristles (14) of brush (10) from fouling or otherwise snagging vertical baffles (48) when brush (10) is fitted inside enclosure (20) in preparation for cleaning and flushing.

Reference FIG. 4b

Wherein a series of exit holes (50) are disclosed in outlet side (22) of enclosure (20). Holes (50) are provided for the purpose of providing escapement for paint contaminated water during flushing procedure of bristles (14) of paint brush (10). Exit holes (50) to be arranged approximately evenly spaced between vertical baffles (48) as viewed on internal surface (27) of outlet side (22) of enclosure (20). Exit holes (50) to measure approximately ⅜″ diameter and be arranged along horizontal line (61) which shows a relative alignment with ¾″ water inlet hole (38) located on inlet side (21) of enclosure (20) when inlet side (21) and outlet side (22) of enclosure (10) is viewed in the closed position as shown in FIG. 5. Alignment of water inlet (38) and exit holes (50) on common horizontal line (61) provide to maintain a relatively straight flow of water from water inlet (38) on inlet side (21) of enclosure (20), through heel (16) of bristles (14) in brush (10), and out exit holes (50) in outlet side (22) of enclosure (20) during paintbrush cleaning and flushing process as indicated by arrows.

Referencing now FIG. 2b

Wherein an integrally molded sealing lip (62) detail is disclosed showing offset (63) integrally formed into parameter of outside edge (64) of outlet side (22) of enclosure (20). Offset (63) is provided for the purpose of forming a seal between inlet side (21) and outlet side (22) of enclosure (20) when enclosure (20) is in the closed position. Sealing lip (62) is comprised of offset (63) measuring approximately .050″ forming integrally molded flange (65) which measures approximately 1/8″ providing for a sealing fit between outside edge (66) of inlet side (21) and outside edge (64) of outlet side (22) of enclosure (20). Sealing lip (62) is intended to reduce leakage of water and pressure around outside edge (64) of outlet side (22) and outside edge (66) of inlet side (21) of enclosure (20) helping to maintain pressure inside enclosure (20) when pressurized water passes from water inlet (38) of inlet side (21), through heel (16) of bristles (14) on brush (10) and out exit holes (50) in outlet side (22) of enclosure (20).

Referencing FIG.1

In certain situations, due to varying paintbrush (10) handle (11) and neck (12) geometry and configurations, it may be desirable to employ additional sealing between neck (12) of handle (11) of paintbrush (10) and handle relief's (26) located on top surfaces (25) of inlet side (21) and outlet side (22) of enclosure (20). For this purpose, an optional rubber sealing bushing (67) is disclosed. Optional bushing (67) would serve the purpose of reducing the escapement of water between neck (12) of handle (11) on paintbrush (10) and handle (11) relief's (26) located on top surfaces (25) of inlet side (21) and outlet side (22) of enclosure (20) when water pressure is introduced to enclosure (20) during flushing operations. Optional sealing bushing (67) to have a length (68) of approximately 1″, an outside diameter (69) of approximately 1″ and an inside diameter (70) of approximately 1/2″. Optional bushing (67) be comprised of a flexible closed cell foam material providing for easy slip on installation when Bushing (67) is fitted over handle (11) of paint brush (10) and seated approximately at neck (12) position on handle (11) or as required for various paintbrush (10) neck (12) configurations.

Referencing FIG. 3

Wherein optional hanger (71) is disclosed for the purpose of suspending enclosure (20) from the top rim of a standard household pail for the purpose of containing contaminated water flushed from bristles (14) and heel (16) of paintbrush (10) during cleaning operations. Hanger (71) to be integrally molded into external surface (28) of outlet side (22) of enclosure (20), directly adjacent to and extending above top surface (25) at a point approximately equidistant between snap buttons (37) on outlet side (14) enclosure (10).

Hanger (71) comprises a hook shaped geometry, wherein hook crown (72) extends approximately 1″ above top surface (25) of outlet side (22) of enclosure (20). Hanger (71) is formed by approximate 180 degree bend in hanger geometry forms throat (73). Throat (73) to measure approximately 1″ in diameter. Said 180 degree bend forms tang (74). Tang (74) extends downward approximately 1″ from crown (72) defining the geometry of optional hanger (71).

Referencing FIG. 7a and 7b

Wherein FIG. 7a shows optional configuration (75) for enclosure (20) wherein pressurized water inlet (38) is positioned adjacent to bottom end (23). Water inlet (38) to be angled providing means for pressurized water to flow in an upward direction as shown by the arrows in fig.7b. Optional configuration (75) would allow for pressurized water to be directed upward from tip (15) of bristles (14) of paintbrush (10) into heel (16) and out exit holes (50) in outlet side (22) of enclosure (75) without the use of the flow directing horizontal baffles (47) or vertical baffles (48) as outlined in the preferred embodiment for enclosure (20). It is important to note that other than the relocation of water inlet (38) and the omission of horizontal baffles (47) and vertical baffles (48), optional enclosure (75) would comprise the same specifications and embodiments as enclosure (20).

Although the invention herein has been described with respect to particular embodiments, it should be understood that these embodiments are only illustrative of the principals and applications of the present invention.

It is therefore to be understood that numerous modifications may be made to the illustrated embodiments and that other arrangements may be devised without departing from the spirit or scope of the present invention as defined by the appended claims.

What is claimed is:

1. A paintbrush cleaning device comprising an enclosure wherein said enclosure is formed by two open sided box sections with means for said open sides of said two open sided box sections to be fixed together forming a chamber wherein at least a portion of said paintbrush can be encapsulated within said enclosure and wherein at least one of the said open sided box sections of said enclosure is provided with means for introducing pressurized water to the inside of said enclosure and; a means for escapement of said pressurized water from said enclosure.

2. The paintbrush cleaning device outlined in claim 1, wherein said two open box sections are pivotally joined together by a hinge.

3. The paintbrush cleaning device outlined in claim 2: wherein said open sided box sections are provided for with a means of sealing one to the other when said two open box sections are arranged in said closed position wherein said chamber is formed.

4. The paintbrush cleaning device outlined in claim 3, wherein said two open sides forming said enclosure are provided for with means of temporarily locking one of the said open sided box sections to the adjoining said open box section allowing for both said open box sections forming said enclosure to retain enclosure in a closed position.

5. The paintbrush cleaning device outlined in claim 4, wherein internal surfaces of said open sided box sections are provided for with baffles as means to direct said pressurized water flow from the point where said pressurized water is introduced to said inside of said enclosure to the point of escapement of said pressurized water from said enclosure.

6. The paintbrush cleaning device outlined in claim 5, wherein said means for introducing pressurized water to said enclosure comprises geometry substantially fixed to at least one of the said open sided box sections wherein a threaded female fitting can be there from attached providing means for connecting to a male threaded portion of water hose.

7. The paintbrush cleaning device outlined in claim 6; wherein said enclosure is provided for with a means to hang or suspend said enclosure from the top rim of a common household pail or bucket.

8. A device for flushing paint contamination from a paintbrush comprises a hollow rectangular chamber arranged to encapsulate the bristles of said paintbrush, a means to introduce pressurized water through said hollow rectangular chamber and a means to exit said pressurized water and said paint contamination from said hollow rectangular chamber, wherein said chamber is formed by interfacing two open faced box sections and wherein said box sections are joined by a hinge member at one side of their parameter providing a means to pivotally swing open or close said rectangular chamber providing means for said chamber to receive said bristle portion of said paintbrush and wherein a means is provided to retain two open faced box sections of said chamber in a closed position.

9. The device for flushing paint contamination from a paintbrush of claim 8, wherein said box sections are provided for with integral molded in locking tabs details substantially fixed on each of said hinged box sections retaining said hinged box sections forming said rectangular chamber, in a closed position.

10. The device for flushing paint contamination from a paintbrush of claim 9, wherein said means to introduce pressurized water to said hollow rectangular chamber comprises geometry wherein an internally threaded female hose connection is fixedly attached to the external surface of at least one of the said box sections providing means for external threaded portion of a garden hose to be mated therein.

11. The device for flushing paint contamination from a paintbrush outlined in claim 10, wherein said hollow rectangular chamber is provided for with an integrally molded hooked shaped hanger arranged to suspend said device from the top rim of common household pail or bucket.
